(19) United States
(12) Patent Application Publication
(10) Pub. No.: US 2026/0008223 A1
(43) Pub. Date: Jan. 8, 2026

(54) METHOD FOR PRODUCING A BLOW-MOLDED PART AND A BLOW-MOLDED PART

(71) Applicant: TI Automotive Technology Center GmbH, Rastatt (DE)

(72) Inventors: Javier BERNEJO, Obanos (ES); Stefan LEIPOLD, Seltz (FR); Manuel LINDOW, Gernsbach (DE); Mikel IRIARTE, Rastatt (DE); Irfan KIZILAY, Reilingen (DE)

(21) Appl. No.: 19/257,142

(22) Filed: Jul. 1, 2025

(30) Foreign Application Priority Data
Jul. 2, 2024 (EP) 24186075.8

(51) Int. Cl. B29C 49/20

(52) U.S. Cl. CPC B29C 49/20; B29C 2049/2008; B29C 2049/2086

(57) ABSTRACT

A method for producing a blow-molded part where a preform made of thermoplastic material is inserted into a blow mold, and a functional element is inserted into the blow mold. The functional element is held in the correct position in the blow mold by a holding device which has a holder that partially accommodates the functional element. The holder has a projection which extends in the longitudinal direction, and the functional element has a flange extending in the radial direction on the side facing the preform. The blow mold is closed and the blow molding operation is performed such that the preform comes to abut the flange of the functional element and forms a base body.

### RELATED APPLICATIONS

The present disclosure claims priority to and the benefit of European Application 24186075.8, filed on Jul. 2, 2024, the entire contents of each of which are incorporated herein by reference.

### FIELD

The present disclosure relates to a method for producing a blow-molded part, in which a functional element is inserted into a blow mold, the functional element is held in the correct position in the blow mold by a holding device, and the holding device has a holder which partially accommodates the functional element such that a preform comes to abut the functional element and forms a base body.

### BACKGROUND

In the blow molding method, a tubular or flat preform is inserted into a blow mold, wherein the blow-molding tools of the blow mold come to abut the outside of the preform and define the outer contour of the blow-molded part. The blow mold usually comprises two blow-molding tools with a cavity that can be moved relative to each other, wherein the preform is pressed off at the edge regions of the cavity of the blow-molding tools when the blow-molding tools are closed.

The blow molding method enables the production of blow-molded parts with a wide variety of shapes, in particular the production of complex-shaped, non-symmetrical, undercut components in a single work step.

It is known from EP 3 919 299 A1 to insert a functional element into the blow-molded part as part of the blow molding method. The functional element is held in the correct position in the blow mold by a holding device and is firmly connected to the preform or the blow-molded part created from the preform during the blow molding operation.

The functional elements are often formed of thermoplastic material and produced by injection molding. We have found that injection-molded parts manufactured from plastic are subject to shrinkage during curing after injection molding, so that large-format functional elements in particular exhibit dimensional inaccuracies with relatively large manufacturing tolerances. During the blow molding operation, we have learned a problem can arise that an undesirable gap is created between the functional element and the preform, which can result in a faulty blow-molded part. Furthermore, the residual wall of the preform can be reduced too much.

### BRIEF SUMMARY

The present disclosure provides a method for producing a blow-molded part which enables simple and cost-effective production of a blow-molded part provided with a functional element.

The method according to the present disclosure for producing a blow-molded part comprises the steps of:
inserting a preform made of thermoplastic material into a blow mold,
inserting a functional element into the blow mold, wherein the functional element is held in the correct position in the blow mold by a holding device, wherein the holding device has a holder which partially accommodates the functional element, wherein the holder has a projection which extends in the longitudinal direction, wherein the functional element has a flange extending in the radial direction on the side facing the preform,
closing the blow mold, and
performing the blow molding operation, wherein the preform comes to abut the flange of the functional element and forms a base body.

The flange of the functional element, which extends in a radial direction, can ensure that the functional element makes abutting contact with the preform and the base body created from the preform along the circumferential edge facing the preform, so that the blow molding operation can achieve a firm material-locking and/or positive-locking connection between the blow-molded part and the functional element. The flange, which extends in a radial direction, is particularly suitable for compensating for manufacturing tolerances of the functional element, so that functional elements can also be installed that have reduced dimensional accuracy due to shrinkage processes. This enables the provision of cost-effectively manufactured functional elements with reduced tolerance requirements.

Preferably, the flange of the functional element comes to abut the surface of the preform during the blow molding operation so that there is full-surface contact between the functional element and the preform. This enables a particularly stable attachment of the functional element and base body.

Preferably, the functional element is connected to the base body in a material-locking manner. It is particularly preferred that the material-locking connection between the functional element and the base is made during the blow molding operation, in which the base body is formed from the preform. During the blow molding operation, the preform made of thermoplastic material is heated to a temperature above the melting temperature so that material-locking connections can be achieved during the blow molding process without additional additives. Depending on the shape of the functional element and base body, the functional element can also form a positive-locking connection with the base body. A combined material-locking and positive-locking connection is also conceivable, wherein a combined connection is particularly robust.

The flange of the functional element can extend over the end face of the projection of the holder. The holder preferably surrounds the functional element radially on the outside and supports the functional element in the correct position inside the blow mold. Here, it is important that the functional element can be easily removed from the holder once the blow molding operation is complete. If the flange of the functional element extends over the end face of the projection of the holder, it is ensured that the flange comes to abut the preform. It is also ensured that the holder remains at a distance from the preform. An undesirable excessive reduction in the residual wall thickness can be avoided. It is particularly advantageous that the residual wall thickness that can be achieved in the area of the connection can meet the minimum requirements for the pressure resistance of the base body.

Preferably, the functional element is made of thermoplastic material so that the functional element can be manufactured easily and cost-effectively. Alternatively, sections of the functional element can be formed of non-thermoplastic material and fitted with connecting elements made of thermoplastic material. The functional element can also be connected mechanically.

Preferably, the functional element is designed as an injection-molded part. The injection molding method enables the production of functional elements in large quantities at low cost.

The blow-molded part can be an arrangement for transporting media. The preform can form a base body with at least one flow channel, wherein the functional element is connected to the flow channel in a flow-conducting manner.

In this context, it is particularly conceivable that the blow-molded part forms a pipe arrangement in which temperature control media can be fed to various components of an electric vehicle, for example the batteries or a heat exchanger for controlling the temperature of the passenger compartment. Both the batteries and the passenger compartment must be either cooled or heated depending on the ambient temperature. The pipe arrangement allows temperature control media with different temperatures to be distributed and fed to different components. The functional element can be equipped to either detect state variables of the temperature control medium or to influence the temperature control medium. In this context, it is conceivable that the functional element is a valve, an internal channel junction, a pump connection, an external line outlet, a sensor connection or the like.

The task is also solved by a blow-molded part, comprising a base body made of thermoplastic material produced by the blow-molding method, in which at least one flow channel is formed, and at least one functional element which is connected to the base body in a material-locking and/or form-locking manner, wherein the functional element is connected to the flow channel in a flow-conducting manner and wherein the functional element has a flange which abuts the base body.

Due to the flange, a full-surface contact of the functional element to the base body results, which enables a more stable connection of the functional element to the base body compared to a linear contact, for example along the end face of a pipe. Furthermore, the flange can compensate for any production-related tolerances of the functional element.

The functional element can have an axial flange, wherein the flange is preferably formed from the axial flange on the side facing the base body. The flange preferably extends in a radial direction.

The functional element is preferably designed as an injection-molded part made of thermoplastic material and the blow-molded part forms an arrangement for transporting media.

### BRIEF DESCRIPTION OF THE DRAWINGS

The method and the blow-molded part produced by the method are explained in more detail in the following figures. The figures show, in each case schematically:

FIG. 1 the blow molding process;

FIG. 2 in detail the base body, the functional element and the holder after completion of the blow molding operation;

FIG. 3 an arrangement for transporting media.

### DETAILED DESCRIPTION

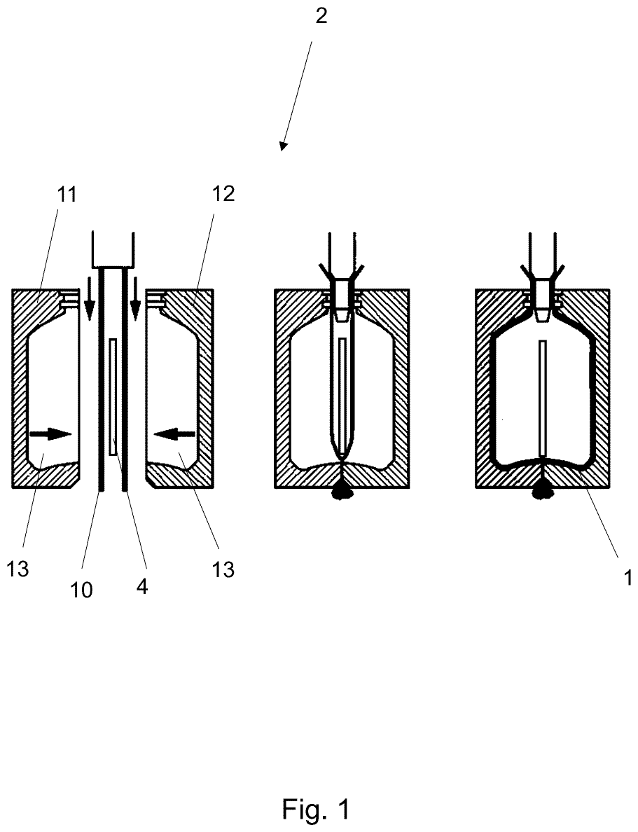

FIG. 1 shows a blow mold 2 with blow-molding tools 11, 12 that can be moved relative to each other. A cavity 13, which defines the outer contour of the blow-molded part 1 produced by the blow-molding method, is inserted into each of the blow-molding tools 11, 12.

To produce the blow-molded part 1, a preform 10 made of thermoplastic material is inserted into the blow mold, a functional element 3 is fastened to a holding device 4 and inserted into the blow mold together with the holding device, wherein the functional element 3 is held in the correct position in the blow mold by the holding device 4. The holding device 4 has a holder 5 that partially accommodates the functional element 3. The holder 5 has a projection 6 that extends in the longitudinal direction and the functional element 3 has a flange 7 extending in the radial direction on the side facing the preform 10 or the base body 8.

The preform 10 is an extruded, tubular body made of polymer material that is heated to a temperature above the melting temperature for the blow molding method. Alternatively, the preform 10 can be formed flat.

For blow molding, the blow mold 2 is closed by moving the blow-molding tools 11, 12 towards each other and the blow molding operation is carried out. During the blow molding operation, the preform 10 abuts the cavity 13 of the blow molding tools 11, 12 and the flange 7 of the functional element 3 and forms a base body 8.

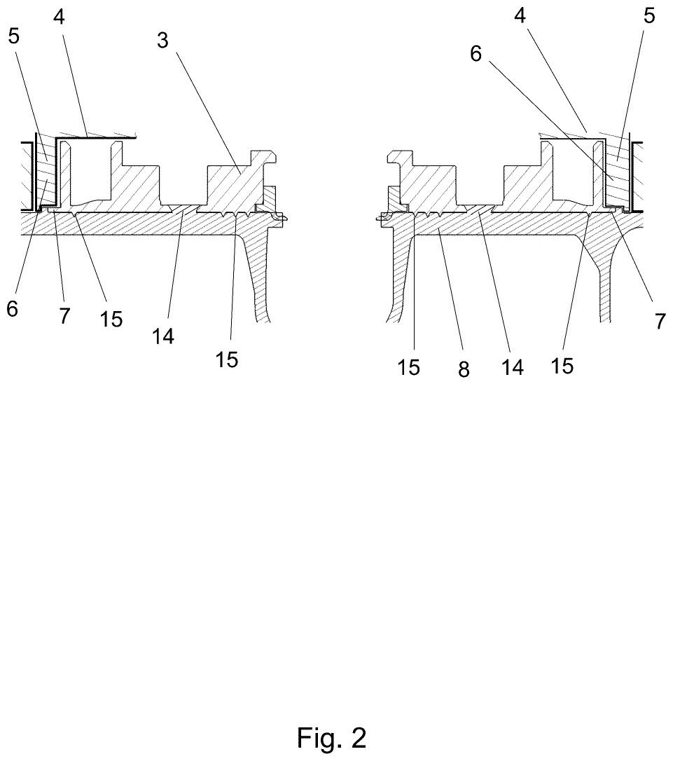

FIG. 2 shows a sectional view of the blow-molded part 1 produced by the method described in FIG. 1. It can be seen that the base body 8 has come to abut the flange 7 of the functional element 3 during blow molding, wherein a full-surface abutment of the flange 7 of the functional element 3 against the surface of the preform 10 is achieved. As the material of the preform 10 is heated to a temperature above the melting temperature, the functional element 3 and the base body 8 are connected to each other in a material-locking manner. The functional element 3 is equipped with welding ribs 15, which melt during the blow molding process and form a material-locking and positive-locking connection with the base body 8. For the positive-locking connection, the base body 8 and the functional element 3 are provided with a form-fit geometry 14. To design the form-fit geometry 14, openings are made in the functional element 3 in the present embodiment, which widen starting from the side facing the base body 8 in the direction of the other side. A dovetail-shaped projection formed from the base body 8 extends into the opening. This undercut geometry results in a positive-locking connection between the base body 8 and the functional element 3.

In an alternative embodiment, functional element 3 and base body 8 are only positively connected. In a further alternative embodiment, functional element 3 and base body 8 are only connected to each other in a material-locking manner.

It can also be seen from FIG. 2 that the functional element 3 is held in the correct position in the blow mold 2 by the holding device 4, wherein the holding device 4 has a holder 5 which partially accommodates the functional element 3. The holder 5 has a projection 6 that extends in the longitudinal direction towards the preform 10. It can also be seen that the flange 7 of the functional element 3 projects beyond the projection 6 of the holder 5 in a radial direction. Accordingly, the flange 7 extends between the end face of the holder 5 and the preform 10 or the base body 8.

The functional element 3 consists of thermoplastic material and is designed as an injection-molded part.

The preform 10 forms a base body 8 with at least one flow channel 9, wherein the functional element 3 is connected to the flow channel 9 in a flow-conducting manner. In the present embodiment, the functional element 3 is a valve or a sensor. The blow-molded part 1 forms an arrangement for transporting media.

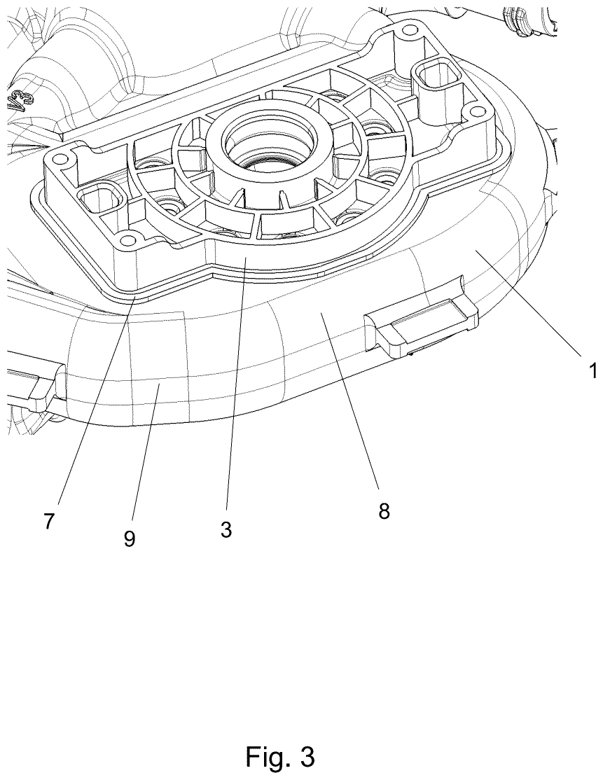

FIG. 3 shows the blow-molded part 1, which is designed as an arrangement for transporting media and comprises a base body 8 made of thermoplastic material produced by the blow molding method, in which at least one flow channel 9 is formed. The functional element 3 is connected to the base body 8 in a positive-locking and material-locking manner, wherein the functional element 3 is connected to the flow channel 9 in a flow-conducting manner. The functional element 3 has a flange 7 that abuts the base body 8. In an alternative embodiment, functional element 3 and base body 8 are only positively connected. In a further alternative embodiment, functional element 3 and base body 8 are only connected to each other in a material-locking manner.

The blow-molded part 1 forms a distribution structure for temperature control media, wherein the blow-molded part 1 is used in a temperature control circuit of an electric vehicle. Temperature control media can be distributed via the blow-molded part 1 and conducted to the devices to be temperature-controlled, for example the batteries, the electric motors, the power electronics or the heat exchangers of the passenger compartment temperature control system.

In the present embodiment, the functional element 3 is formed as a connecting component and can be used to connect the blow-molded part 1 directly to other components of the vehicle. Alternatively, the functional element 3 can also be formed as a connection piece and serve to accommodate hoses for connecting components to the blow-molded part 1. It is also conceivable that the functional element 3 is a valve or a sensor.

1. A method for producing a blow-molded part, comprising the steps of:
inserting a preform made of thermoplastic material into a blow mold,
inserting a functional element into the blow mold, wherein the functional element is held in the correct position in the blow mold by a holding device, wherein the holding device has a holder which partially accommodates the functional element, wherein the holder has a projection which extends in the longitudinal direction, wherein the functional element has a flange extending in the radial direction on the side facing the preform,
closing the blow mold,
performing the blow molding operation, wherein the preform comes to abut the flange of the functional element and forms a base body.

2. The method according to claim 1, wherein the flange of the functional element comes to abut the surface of the preform.

3. The method according to claim 1, wherein the functional element is connected to the base body in a material-locking and/or positive-locking manner.

4. The method according to claim 1, wherein the flange of the functional element extends over an end face of the projection of the holder.

5. The method according to claim 1, wherein the functional element consists of thermoplastic material.

6. The method according to claim 1, wherein the functional element is formed as an injection-molded part.

7. The method according to claim 1, wherein the blow-molded part is configured for transporting media.

8. The method according to claim 1, wherein the preform forms a base body with at least one flow channel, wherein the functional element is connected to the flow channel in a flow-conducting manner.

9. The method according to claim 1, wherein the functional element is a valve, an internal channel junction, a pump connection, an external line outlet or a sensor connection.

10. A blow-molded part, comprising a base body made of thermoplastic material produced by the blow molding method, in which at least one flow channel is formed, and at least one functional element which is connected to the base body in a material-locking and/or positive-locking manner, wherein the functional element is connected to the flow channel in a flow-conducting manner, wherein the functional element has a flange which abuts the base body.

11. The blow-molded part according to claim 10, wherein the functional element has an axial flange.

12. The blow-molded part according to claim 10, wherein the flange extends in a radial direction.

13. The blow-molded part according to claim 10, wherein the functional element is formed as an injection-molded part from thermoplastic material.

14. The blow-molded part according to claim 10, wherein the blow-molded part forms an arrangement for transporting media.
